(19) United States
(12) Patent Application Publication
(10) Pub. No.: US 2010/0291247 A1
(43) Pub. Date: Nov. 18, 2010

(54) OIL FORMULATIONS AND METHODS OF USE

(76) Inventors: Yueh Wang, Arlington Heights, IL (US); Bassam Shammo, Mundelein, IL (US); Rebecca Dickenson, Volo, IL (US); John Lopez, Gurnee, IL (US); Judith Fugiel, Lake Villa, IL (US); Linda Rehberger, Glenview, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/845,269

(22) Filed: Jul. 28, 2010

Related U.S. Application Data
(63) Continuation of application No. 12/152,787, filed on May 16, 2008.
(60) Provisional application No. 60/930,747, filed on May 18, 2007.

(51) Int. Cl. A01N 65/20; A01P 5/00

(52) U.S. Cl. 424/757

(57) ABSTRACT

The invention generally relates to various essential oil formulations for protecting plants from nematodes and other pathogens. The invention provides specific formulations which do not require the use of chemical additives. These formulations have low phytotoxicity and low volatility. Also, methods of applying the formulations for agricultural use are disclosed.

### CROSS-REFERENCE TO RELATED APPLICATION

This application is a continuation application of Ser. No. 12/152,787, filed May 16, 2008, which claims priority of Ser. No. 60/930,747, filed May 18, 2007.

### FIELD OF THE INVENTION

The present invention generally relates to essential oil EC formulations for protecting the plants from nematode and other pathogens and their methods of use.

### BACKGROUND OF THE INVENTION

Plant parasitic nematodes cause serious economic damage to many agricultural crops around the world. The nematodes in this group are microscopic worms and are, in general, obligate parasites of plants. They feed mostly on the roots of host plants; however, several genera are known to parasitize above-ground parts including stems, leaves and flowers as well. Almost all the plant species of economic importance are susceptible to infection by some species of nematodes (notable exceptions are in the marigolds and asparagus). For example, root knot nematodes (RKN), (Meloidogyne spp.) are capable of parasitizing more than 3,000 species of crop plants. These plants include agronomic crops, vegetables, fruits, flowering trees and shrubs. Nematodes reportedly cause crop loss of more than six billion dollars in the United States alone and more than one hundred billion dollars around the world.

The symptoms due to parasitic nematode injury vary widely depending on the plant host, the nematode species, age of the plant, geographical location and climatic and external environmental conditions. In general, an overall patchy appearance of plants in a field is considered indicative of nematode infestation. More specifically, nematode injury results in galling of the roots (abnormal swelling in the tissue due to rapid multiplication of cells in the cortical region) caused by species of root knot (Meloidogyne spp.) and cyst (Heterodera spp.) nematodes, lesions (localized, discolored areas) caused by lesion nematodes (Pratylenchus spp.), suppression of cell division resulting in stubby roots (Trichodorus spp.), growth abnormalities including crinkling or twisting of above-ground parts (Aphelenchoides spp.) and even cell necrosis (death) in some cases. Plant parasitic nematodes may be endoparasitic in nature, as in the case of the root-knot and lesion nematodes, or ectoparasitic as in the dagger nematode (Xiphinema spp.) and lance nematode (Hoplolaimus spp.). Nematodes can be vectors of plant viruses and are also known to induce disease complexes predisposing plants to infection by other plant pathogenic fungi and bacteria.

Chemical nematocides, either soil fumigants or non-fumigants, have been in use for many years and are among the few feasible options for countering nematodes. At present, the process involves repeated applications of synthetic chemicals to the ground prior to planting the crop. These chemicals are extremely toxic to organisms besides nematodes and many of them may pose serious threats to the environment. With the renewed emphasis on clean water and air by environmental groups and governmental agencies, and the detection of many of these active ingredients or the metabolites thereof in ground water and several non-target organisms, there has been serious concern as to the manufacture and/or use of these chemicals. One of the most effective, economical, and widely used nematocides, DBCP (1,2-dibromo-3-chloropropane), found in ground water has been judged to induce male sterility and possible carcinogenesis. Another widely used chemical, EDB (ethylene dibromide), has also been found in ground water.

Yet another very common insecticide-nematocide, aldicarb (2-methyl-2-(methylthio)-propionaldehyde-O-(methylcarbamoyl)oxime), has been found to be acutely toxic. Aldicarb has been found in ground water in several regions of United States. Carbofuran (2,3-dihydro-2,2-dimethyl-7-benzofuranyl methylcarbamate) and 1,3-D (1,3-dichlorpropane), two very commonly used nematocides, are under special review by the EPA because of their avian toxicity and possible carcinogenic effects. More recently, the decision by the EPA to limit and eventually discontinue the use of the soil fumigant, methyl bromide, for agricultural purposes presents a threat to the efficiency and quality of agricultural production in the United States.

Natural isolates such as N-acetyl-D-glucosamine, which may be derived from microorganisms which are the waste products of industrial fermentation processes, have been disclosed as nematocidal in U.S. Pat. No. 5,057,141.

Biopesticides have been developed as an alternative to chemical pesticides. They are obtained by fermentation and can be used either as crude biomass or purified. Typically, fermentations are carried out at temperatures in the range of 20-40° C. For example, submerged fermentation at 28-30° C. of Paecilomyces fumosoroues fungal isolate ATCC No. 20874 produces fungal biomass for control of nematode infestation as disclosed in U.S. Pat. No. 5,360,607; whole fermentation broth from fermentation at 28.degree. C. of Streptomyces thermoarchaensis NCIB 12015 is disclosed as nematocidal in U.S. Pat. No. 5,182,207; fermentation broth obtained from fermentation of Streptomyces cyaneogriseus noncyanogenus NRRL 15773 at 28° C. is effective against nematodes as disclosed in U.S. Pat. No. 5,439,934; and fermentation broth obtained by fermentation of the fungus Myrothecium verrucaria at temperatures of from 25 to 30° C. is disclosed as nematocidal in U.S. Patent No. 5,051,255.

However, there is still a need for the development of new and effective nematocides. Plants were suggested as a source of effective pesticidal compounds as many plant essential oils exhibit antimicrobial, insecticidal, fungicidal and herbicidal activity. They have been applied as pesticides for pest, disease and weed management.

Plant essential oils which do not present any known risk to humans or to the environment are qualified for an exemption as minimum risk pesticides and are listed in 40 C.F.R. § 152.25 (b). However, high volatility, phytotoxicity and low water solubility of some oils have limited their uses in crop protection.

One plant essential oil used in agricultural applications is ProGuard® 30% Cinnamaldehyde Flowable Insecticide, Miticide, and Fungicide. See U.S. Patent Nos. 6,750,256 B1 and 6,251,951 B1. However, a downside of this commercial product is that it contains the chemical preservative o-Phenylphenol.

Nematicidal activity of plant essential oils was reported, among others, by Y.Oka (Nematology, Vol. 3(2), pp. 159-164, 2001) and R. Pandey (J. Phytopathology 148, 501-502 (2000)). Essential oils of some plants and their components have been tested for nematicidal activity in vitro and in soil. Some plant essential oils which were determined to have nematicidal activity include essential oils of applemint (Mentha rotundifolia), caraway (Carum carvi), fennel (Foeniculum vulgare), oregano (Origanum vulgare), Syrian oregano (Origanum syriacum) and wild thyme (Coridothymus capitatus). Also, it was reported that aromatic and aliphatic aldehydes, including cinnamic aldehyde (also known as cinnamaldehyde) possess strong nematicidal activity in vitro. For example, U.S. Pat. No. 6,251,951 B1 demonstrates that cinnamaldehyde has nematicidal activity in the presence of 2% Tween 80 and 6% NaHCO₃ vehicle.

However, prior art essential oil formulations include various chemicals, such as ethanol, DMSO solvent, Tween 80 surfactants and others. One of the problems associated with the use of such chemicals is that they are often phytotoxic and limit the commercial applications of the compositions.

Accordingly, there is a need to develop a safe and easy-to-use formulation to improve the biological effectiveness of plant essential oils for agricultural applications. This formulation would have low volatility and low phytotoxicity and would not include phytotoxic chemicals.

### SUMMARY OF THE INVENTION

The invention generally relates to formulations suitable for agricultural use comprising essential oils (e.g., citronella oil, phenethyl proprionate, gamma-nonanoic lactone gamma-undecanoic lactone and vanillin), at least one solvent selected from the group consisting of soybean oil, methyl oleate, ethyl lactate and methyl soyate, and an emulsifier, wherein said formulations do not include an organic solvent, a surfactant or a detergent.

In one embodiment, the invention provides a formulation suitable for agricultural use comprising citronella oil, soybean oil and an ethoxylated soybean oil, wherein said formulation does not include an organic solvent, a surfactant or a detergent. In a preferred embodiment, citronella oil comprises about 50% by weight of the total formulation and soybean oil comprises about 40% by weight of the total formulation and ethoxylated soybean oil emulsifier comprises about 10% by weight of the total formulation.

In another embodiment, the invention provides a formulation suitable for agricultural use comprising phenethyl proprionate, soybean oil and an ethoxylated soybean oil, wherein said formulation does not include an organic solvent, a surfactant or a detergent. In a preferred embodiment, phenethyl proprionate comprises about 50% by weight of the total formulation, soybean oil comprises about 40% by weight of the total formulation and ethoxylated soybean oil comprises about 10% by weight of the total formulation

In yet another embodiment, the invention provides a formulation suitable for agricultural use comprising gamma-nonanoic lactone (also known as coconut aldehyde), soybean oil and polyethylene sorbitol hexaoleate, wherein said formulation does not include an organic solvent, a surfactant or a detergent. In a preferred embodiment, gamma-nonanoic lactone comprises about 50% by weight of the total formulation, soybean oil comprises about 40% by weight of the total formulation and polyethylene sorbitol hexaoleate comprises about 10% by weight of the total formulation.

In yet another embodiment, the invention provides a formulation suitable for agricultural use comprising gamma-undecanoic lactone (also known as cotton aldehyde), soybean oil and polyethylene sorbitol hexaoleate, wherein said formulation does not include an organic solvent, a surfactant or a detergent. In a preferred embodiment, gamma-undecanoic lactone comprises about 50% by weight of the total formulation, soybean oil comprises about 40% by weight of the total formulation and polyethylene sorbitol hexaoleate comprises about 10% by weight of the total formulation.

In yet another embodiment, the invention provides a formulation suitable for agricultural use comprising Vanillin (4-hydroxy-3-methoxybenzaldehyde) flavor agent in 15% microemulsion formulation with 75% ethyl lactate solvent and ethoxylated sorbitol monooleate emulsifier.

In another embodiment, the invention provides a method of protecting a plant from at least one pathogen comprising applying to the plant an effective amount of the claimed formulations. In one embodiment, the pathogen may be a nematode.

In one embodiment, the plant may be a cucumber; in another embodiment, the plant may be a melon; in yet another embodiment, the plant may be a tomato.

In one embodiment, the application of the formulation is performed by drenching or dripping.

In one embodiment, the effective amount is sufficient to provide at least about 95% percent gall reduction.

In another embodiment, the effective amount is sufficient to provide at least about 90% inhibition of growth of Pythium.

In yet another embodiment, the effective amount is sufficient to provide at least about 90% inhibition of growth of Rhizoctonia.

In yet another embodiment, the effective amount is sufficient to provide at least about 90% inhibition of growth of Sclerotinia.

These representative embodiments are in no way limiting and are described solely to illustrate some aspects of the invention.

### DETAILED DESCRIPTION OF THE INVENTION

The present invention generally relates to formulations suitable for agricultural use comprising essential oils (e.g., citronella oil, phenethyl proprionate, gamma-nonanoic lactone, gamma-undecanoic lactone and vanillin), at least one solvent selected from the group consisting of soybean oil, methyl oleate, ethyl lactate, and methyl soyate, and an emulsifier, wherein said formulations do not include an organic solvent, a surfactant, or a detergent.

The invention further relates to methods for protecting a plant from at least one pathogen comprising applying to the plant an effective amount of the claimed formulations. The phrase “protecting a plant” means controlling the growth of pathogens, which may involve killing the pathogen and/or slowing or arresting its proliferation. Representative pathogens include, but are not limited to, nematodes, Pythium, Rhizoctonia, and Sclerotinia.

Essential oils have been reported to have nematicidal activity. There are prior art pesticidal formulations employing essential oils. However, known formulations contain undesirable additives, such as chemical solvents, surfactants (i.e., Tween-80), and/or detergents. Applicants have surprisingly discovered novel essential oil formulations which do not contain these undesirable additives, have low volatility, low phytotoxicity and are safe and easy to use. Applicants have discovered that natural solvents, such as soybean oil, methyl oleate, ethyl lactate, and methyl soyate can be used instead of the chemical additives to prepare pesticidal essential oil formulations.

A person of ordinary skill in the art would readily recognize that essential oils and other compounds of the invention can be either isolated from a natural source, be wholly or partly synthetic or be produced by recombinant techniques.

The formulation should also include an emulsifier. In one preferred embodiment, the emulsifier is polyethylene sorbitol hexaoleate. Other suitable emulsifiers include, but are not limited to, ethoxylated soybean oil and sorbitol monooleate.

The formulation may also include an antioxidant. Many suitable antioxidants may be used in accordance with this invention. In a preferred embodiment, the antioxidant is TBHQ.

### Citronella Oil Formulations

In one embodiment, the invention provides a formulation suitable for agricultural use comprising citronella oil, soybean oil and an ethoxylated soybean oil, wherein said formulation does not include an organic solvent, a surfactant or a detergent. In a preferred embodiment, citronella oil comprises about 50% by weight of the total formulation and soybean oil comprises about 40% by weight of the total formulation and ethoxylated soybean oil emulsifier comprises 10% by weight of total formulation.

### Phenethyl Proprionate Formulations

In another embodiment, the invention provides a formulation suitable for agricultural use comprising phenethyl proprionate, soybean oil and an ethoxylated soybean oil, wherein said formulation does not include an organic solvent, a surfactant or a detergent. In a preferred embodiment, phenethyl proprionate comprises about 50% by weight of the total formulation, soybean oil comprises about 40% by weight of the total formulation, and ethoxylated soybean oil comprises about 10% by weight of the total formulation.

### Gamma-nonanoic Lactone (Coconut Aldehyde) Formulations

In yet another embodiment, the invention provides a formulation suitable for agricultural use comprising gamma-nonanoic lactone (also known as coconut aldehyde), soybean oil and polyethylene sorbitol hexaoleate, wherein said formulation does not include an organic solvent, a surfactant or a detergent. In a preferred embodiment, gamma-nonanoic lactone comprises about 50% by weight of the total formulation, soybean oil comprises about 40% by weight of the total formulation and polyethylene sorbitol hexaoleate comprises about 10% by weight of the total formulation.

### Gamma-undecanoic Lactone (Cotton Aldehyde) Formulations

In yet another embodiment, the invention provides a formulation suitable for agricultural use comprising gamma-undecanoic lactone (also known as cotton aldehyde), soybean oil and polyethylene sorbitol hexaoleate, wherein said formulation does not include an organic solvent, a surfactant or a detergent. In a preferred embodiment, gamma-undecanoic lactone comprises about 50% by weight of the total formulation, soybean oil comprises about 40% by weight of the total formulation and polyethylene sorbitol hexaoleate comprises about 10% by weight of the total formulation.

In one embodiment of the present invention, the formulations used in accordance with the present invention include from 1 ppm to 10,000 ppm of essential oil; preferably, from 1 ppm to 5,000 ppm of essential oil, and most preferably, from 1 ppm to 500 ppm of essential oil.

In another embodiment, the invention provides a method of protecting a plant from at least one pathogen comprising applying to the plant an effective amount of the claimed formulations. In one embodiment, the pathogen may be a nematode.

In one embodiment, the plant may be a cucumber; in another embodiment, the plant may be a melon; in yet another embodiment, the plant may be a tomato.

In one embodiment, the application of the formulation is performed by spraying.

In one embodiment, the effective amount is sufficient to provide at least about 95% percent gall reduction.

In another embodiment, the effective amount is sufficient to provide at least about 90% inhibition of growth of Pythium.

In yet another embodiment, the effective amount is sufficient to provide at least about 90% inhibition of growth of Rhizoctonia.

In yet another embodiment, the effective amount is sufficient to provide at least about 90% inhibition of growth of Sclerotinia.

These representative embodiments are in no way limiting and are described solely to illustrate some aspects of the invention.

The methods of the present invention are carried out by applying to a plant host or to the substrate in which it is growing or is to be growing an effective amount of the claimed formulations. The phrase “effective amount” means a sufficient amount of the formulation to provide the desired effect. The amount may vary depending on the specific plant, degree of infestation, and other factors. It is well within an ordinary skill in the art to determine the necessary amount of the formulation.

The unit commonly used in the art to determine the effectiveness of the antipathogenic formulation is LC₅₀. This number represents the concentration of formulation at which 50% of pathogens die.

The formulations may be applied by spraying, pouring, dipping, in the form of concentrated liquids, solutions, suspensions, and the like. They may be applied, for example, in the form of dilute solution, in a suitable natural solvent directly to the plants either as part of an irrigation schedule or as a separate application.

As used herein, all numerical values relating to amounts, weight percentages, and the like are defined as “about” or “approximately” each particular value, plus or minus 10%. Therefore, amounts within 10% of the claimed values are encompassed by the scope of the claims.

The following examples are offered by way of illustration only and not by way of limitation.

### EXAMPLE 1

### 50% Citronella Oil EC Formulation

Preparation

The following amounts of the ingredients were used to prepare this formulation:

50.0% by weight of the total formulation of citronella oil;

40.0% by weight of the total formulation of soybean oil; and

10.0% by weight of ethoxylated soybean oil.

Nematicidal Activity

The formulation was applied against root knot nematodes (2^{nd} stage juvenile Meloidogyne incognita).

LC₅₀ (Meloidogyne incognita): 327 ppm

Greenhouse Pot Test

The formulation was used in greenhouse cucumber seedling assays.

At drench concentration of 1000 ppm, 30% gall reduction was achieved.

At drench concentration of 500 ppm, 6% gall reduction was achieved.

### EXAMPLE 2

### 50% Phenethyl Proprionate EC Formulation

Preparation

The following amounts of the ingredients were used to prepare this formulation:

50.0% by weight of the total formulation of phenethyl proprionate;

40.0% by weight of the total formulation of soybean oil; and

10.0% by weight of ethoxylated soybean oil.

Nematicidal Activity

The formulation was applied against root knot nematodes (2^{nd} stage juvenile Meloidogyne incognita).

LC₅₀ (Meloidogyne incognita): 255 ppm

Greenhouse Pot Test

The formulation was used in greenhouse cucumber seedling assays.

At drench concentration of 1000 ppm, 31% gall reduction was achieved.

At drench concentration of 500 ppm, 30% gall reduction was achieved.

### EXAMPLE 3

### 50% Gamma-nonanoic Lactone (Coconut Aldehyde) EC Formulation

Preparation

The following amounts of the ingredients were used to prepare this formulation:

50.0% by weight of the total formulation of gamma-nonanoic lactone;

40.0% by weight of the total formulation of soybean oil; and

10.0% by weight of polyethylene sorbitol hexaoleate.

Nematicidal Activity

The formulation was applied against root knot nematodes (2^{nd} stage juvenile Meloidogyne incognita).

LC₅₀ (Meloidogyne incognita): 492 ppm

### EXAMPLE 4

### 50% Gamma-undecanoic Lactone (Cotton Aldehyde) EC Formulation

Preparation

The following amounts of the ingredients were used to prepare this formulation:

50.0% by weight of the total formulation of gamma-undecanoic lactone;

40.0% by weight of the total formulation of soybean oil; and

10.0% by weight of polyethylene sorbitol hexaoleate.

Nematicidal Activity

The formulation was applied against root knot nematodes (2^{nd} stage juvenile Meloidogyne incognita).

LC₅₀ (Meloidogyne incognita): 121 ppm

Greenhouse Pot Test

The formulation was used in greenhouse cucumber seedling assays.

At drench concentration of 4000 ppm, 100% gall reduction was achieved.

### EXAMPLE 5

### 15% Vanillin (4-Hydroxy-3-Methoxybenzaldehyde) MEC Formulation

Preparation

The following amounts of ingredients were used to prepare this formulation.

15% Vanillin

75% Ethyl Lactate

10% Ethoxylated Sorbitol Monooleate

LC₅₀ : 437 ppm of the formulation or 66 ppm of Vanillin The dilution gives a clear microemulsion of insoluble Vanillin.

1. A method of protecting a plant from at least one pathogen comprising applying to the plant or soil an effective amount of a formulation suitable for agricultural use comprising at least one plant essential oil, at least one solvent selected from the group consisting of soybean oil, methyl oleate, ethyl lactate, and methyl soyate, and at least one emulsifier, provided that said formulation does not include an organic solvent or a detergent.

2. The method of claim 1, wherein the essential oil is selected from the group consisting of citronella oil, phenethyl proprionate, gamma-nonanoic lactone, gamma-undecanoic lactone, and 4-hydroxy-3-methoxybenzaldehyde.

3. The method of claim 1, wherein the essential oil is citronella oil.

4. The method of claim 1, wherein the pathogen is a nematode.

5. The method of claim 1, wherein the emulsifier is polyethylene sorbitol hexaoleate.

6. The method of claim 1, wherein the formulation is applied to soil.

7. The method of claim 1, wherein the essential oil is citronella oil and the solvent is soybean oil.

8. The method of claim 1, wherein the essential oil selected from the group consisting of phenethyl proprionate, gamma-nonanoic lactone, gamma-undecanoic lactone, and 4-hydroxy-3-methoxybenzaldehyde.

9. The method of claim 4, wherein the formulation is applied to soil.

10. The method of claim 9, wherein the essential oil is gamma-undecanoic lactone.

11. The method of claim 9, wherein the essential oil is citronella oil.

12. The method of claim 9, wherein the essential oil is phenethyl proprionate.

13. The method of claim 9, wherein the essential oil is 4-hydroxy-3-methoxybenzaldehyde.

14. The method of claim 9, wherein the essential oil is gamma-nonanoic lactone.

15. The method of claim 9, wherein the essential oil is citronella oil and the solvent is soybean oil.

16. The method of claim 15, wherein the emulsifier is ethoxylated soybean oil.

17. A formulation suitable for agricultural use comprising at least one plant essential oil selected from the group consisting of citronella oil, phenethyl proprionate, gamma-nonanoic lactone, gamma-undecanoic lactone, and 4-hydroxy-3-methoxybenzaldehyde, at least one solvent selected from the group consisting of methyl oleate, ethyl lactate, and methyl soyate, and at least one emulsifier, provided that said formulation does not include an organic solvent or detergent.

18. The formulation of claim 17, wherein said emulsifier is selected from the group consisting of ethoxylated soybean oil, polyethylene sorbitol hexaoleate, and ethoxylated sorbitol monooleate.

19. A formulation suitable for agricultural use comprising at least one plant essential oil selected from the group consisting of phenethyl proprionate, gamma-nonanoic lactone, gamma-undecanoic lactone, and 4-hydroxy-3-methoxybenzaldehyde, at least one solvent selected from the group consisting of soybean oil, methyl oleate, ethyl lactate, and methyl soyate, and at least one emulsifier, provided that said formulation does not include an organic solvent or detergent.

20. The formulation of claim 19, wherein said emulsifier is selected from the group consisting of ethoxylated soybean oil, polyethylene sorbitol hexaoleate, and ethoxylated sorbitol monooleate.
